(19) United States
(12) Patent Application Publication
(10) Pub. No.: US 2002/0114599 A1
(43) Pub. Date: Aug. 22, 2002

(54) Optical fibre

(76) Inventors: Ross Halgren, Eveleigh (AU); Mark Summerfield, Eveleigh (AU)

Correspondence Address: CHRISTIE, PARKER & HALE, LLP, P.O. BOX 7068, PASADENA, CA, 91109-7068, US

(21) Appl. No.: 09/965,396

(22) Filed: Sep. 26, 2001

(30) Foreign Application Priority Data
Nov. 10, 2000 (AU) PR 1385

(51) Int. Cl. G02B 6/16; G02B 6/18; G02B 6/22; G02B 6/26

(52) U.S. Cl. 385/123; 385/124; 385/127; 385/28

(57) ABSTRACT

An optical fibre comprising at least one single core structure arranged in a manner such that, in use, it supports both single-mode and multi-mode propagation for data transfer.

### FIELD OF THE INVENTION

The present invention relates broadly to an optical fibre.

### BACKGROUND OF THE INVENTION

Fibre-optic multiplexers and switches in general and Wavelength Division Multiplexers (WDM) in particular often include a range of transceiver and fibre interface options, such as 850 nm multi-mode, 1310 nm multi-mode, 1310 nm single-mode and 1550 nm single-mode.

Typically, such a broad range of interface options occurs in multiplexers and switches that interface to different subscriber equipment having different protocols and transmission requirements.

In such implementations, flexibility and/or upgradeability can be adversely effected through the necessity to use dedicated single-mode and dedicated multi-mode fibre connections, as interconnect cabling may have to be changed whenever a new type of e.g. interface card is to be installed. SUMMARY OF THE INVENTION

In accordance with a first aspect of the present invention there is provided an optical fibre comprising at least one single core structure arranged in a manner such that, in use, it supports both single-mode and multi-mode propagation for data transfer.

Preferably, the fibre is arranged in a manner such that the fundamental mode of the single core structure is substantially matched to a transverse profile of a single-mode optical signal intended for propagation in the single core structure.

In one embodiment, the single core structure comprises an inner core region having a first diameter and a first refractive index, a second core region located concentrically around the first core region and having a second diameter and a second refractive index, and a cladding region having a third refractive index.

The first refractive index may be greater than the second refractive index which in turn may be greater than the third refractive index.

In one embodiment, the first diameter is about 9 μm, and the second diameter is about 50 μm.

The second core region may have a graded index profile along its diameter. The graded index profile may comprise a parabolic refractive index profile.

The optical fibre may e.g. be glass-based or polymer-based.

In accordance with a second aspect of the present invention, there is provided a method of connecting an optical fibre as defined in the first aspect to an external single-mode fibre having a mode-profile that is not substantially identical to a fundamental mode of the optical fibre, the method comprising the step of inter-connecting a length of matched single-mode optical fibre between the external single-mode fibre and the optical fibre, wherein the transverse single-mode profile of the matched single-mode fibre is substantially identical to the fundamental mode of the optical fibre.

In accordance with a third aspect of the present invention, there is provided an optical interconnecting device comprising an optical fibre as defined in the first aspect.

In accordance with a fourth aspect of the present invention, there is provided an optical network element incorporating an optical interconnecting device as defined in the third aspect.

Preferred forms of the invention will now be described, by way of example only, with reference to the accompanying drawings.

### BRIEF DESCRIPTION OF THE DRAWINGS

FIG. 1 is a schematic cross-sectional view of an optical fibre embodying the present invention.

FIG. 2 is a schematic drawing illustrating the inter-connection of two single-mode fibres to an optical fibre embodying the present invention.

FIG. 3 is a schematic diagram illustrating a network element embodying the present invention.

### DETAILED DESCRIPTION OF THE EMBODIMENTS

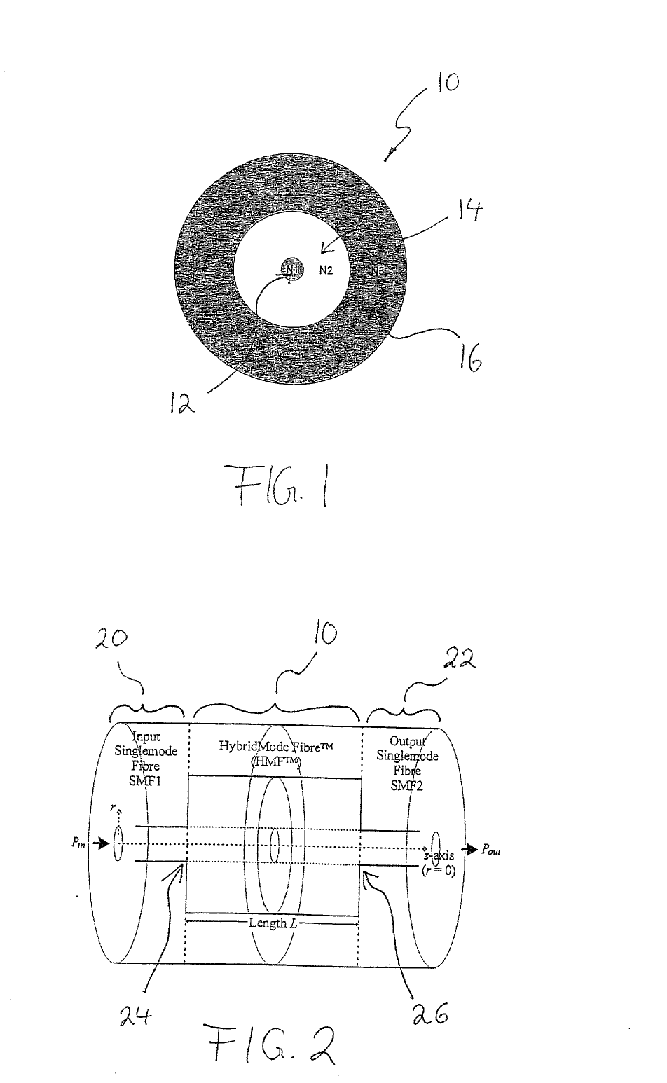

An embodiment of an optical fibre of the invention is shown in FIG. 1. The structure of the fibre core consists of three concentric regions of different refractive index, with a step-change in index between each region. The central region 12, hereinafter “the single-mode core region”, has the highest refractive index, and a diameter of about 9 μm roughly equal to that of standard single-mode fibre. The region 14 surrounding this, hereinafter “the multi-mode core region”, has a lower index, and a diameter of about 50 μm roughly equal to that of common multi-mode fibres. The outer region 16 is the cladding region, which has the lowest refractive index and a diameter of 125 μm, equal to that of all common telecommunications fibres.

The fibre 10 exhibits the following key characteristics:

it can support a stable fundamental mode of propagation whose characteristics are a close match for those of the fundamental mode of standard single-mode fibre;

it can support a number of higher-order modes of propagation closely matched in number and characteristics to those of common multi-mode fibres.

The fibre 10 shown in FIG. 1 can achieve these characteristics in the following manner:

for single-mode propagation the single-mode core region 12 of highest refractive index acts as the core, with the “multi-mode core” region 14 acting as the cladding;

for multi-mode propagation, the multi-mode core region 14 acts as the core, and the cladding region 16 acts as the cladding. The single-mode core region 12 has a minimal effect on the multi-mode propagation characteristics of the fibre.

One parameter which determines the efficiency with which light is coupled from the fundamental mode of a single-mode fibre to the fundamental mode of the fibre 10 is how closely-matched the transverse mode profiles and propagation constants of the two fundamental modes are to each other. A mismatch in propagation constants will lead to some reflection of power at the interface between the two fibres (Fresnel reflections). A mismatch in mode profiles will lead to a loss of power coupled into the fundamental mode of the fibre 10. This power will, instead, be coupled into certain of the modes of the multi-mode region 14—primarily the lower-order axial modes, which have the largest overlap with the fundamental mode of the single-mode fibre.

This process is symmetric, i.e. it occurs also when light is coupled from the fibre 10 back into single-mode fibre again. In this case, the lost power is coupled into cladding modes of the single-mode fibre, which are only weekly guided and are typically radiated out of the cladding after a short propagation distance.

FIG. 2 illustrates an interconnection consisting of an input single-mode fibre 20 carrying the input signal of optical power Pᵢₙ, a section of fibre 10 of length L meters, and an output single-mode fibre 22 carrying the output signal of optical power Pout. The purpose of the following analysis is to illustrate the behaviour of the transfer characteristic Pₒᵤₜ/Pᵢₙ as a function of the parameters of the fibre 10. Each of the single-mode fibres 20, 22 supports only a single fundamental LP₀₁ mode of propagation, with propagation constant β_{SMF.} The fibre 10 in general supports a large number of modes, denoted by LPₗₘ with propagation constants βₗₘ where l and m are integer mode indices. The most important of these will be the LP₀ₘ modes, which are the axial modes. Assuming the cores of the single-mode fibres 20, 22 and fibre 10 are accurately aligned, as they should be if single-mode connectors (not shown) are being used, significant coupling of light will only occur between the fundamental mode of single-mode fibres 20, 22 respectively and the axial modes of the fibre 10.

At the interfaces 24, 26 between the respective single-mode fibres 20, 22 and the fibre 10, the fraction of power η₀ₘ coupled between the fundamental LP ₀₁ mode of the fibres 20, 22 and each LP₀ₘ mode of the fibre 10 is given by the overlap integral:

$${η}_{0 m} = {[ \frac{{\int }_{0}^{∞} ψ ( r ) {ξ}_{0 m} ( r ) r ⅆ r}{\sqrt{{\int }_{0}^{∞} {ψ}^{2} ( r ) r ⅆ r} \sqrt{{\int }_{0}^{∞} {ξ}_{0 m}^{2} ( r ) r ⅆ r}} ]}^{2} \qquad ( 1 )$$

In this equation, ψ(r) is the transverse mode profile of the fundamental mode of the single-mode fibres 20, 22, and ξ₀ₘ(r) are the transverse field profiles of the fibre 10 modes. Since only the circularly-symmetric axial modes are considered, there is no θ-dependence of these field profiles, which simplifies the integrals. This overlap integral will be unity if and only ifψ(r) and ξ₀ₘ(r) are identical, otherwise it is less than one. It is also noted that Σₘ72 ₀ₘ≦1, i.e. the total power coupled into all modes of the fibre 10 can be no greater than the power input from the fibre 20. This condition is obviously a physical requirement, however it is also guaranteed to be true mathematically, because the ξ₀ₘ(r) are orthogonal functions. Note that at the output 26 of the fibre 10, any power not coupled into guided modes of the fibre 22 is lost to cladding modes, and eventually exits the fibre 22 completely.

After propagating through the length L of fibre 10, assuming no other sources of attenuation in the system, the fraction of the original input power coupled to the output fibre 22 is:

$$\begin{matrix}\frac{{P}_{out}}{{P}_{i n}} = \vert {\sum }_{m} {η}_{0 m} {e}^{i ( {β}_{0 m} L )} {\vert}^{2} \\ = {\sum }_{m} {η}_{0 m}^{2} + 2 {\sum }_{m} {\sum }_{n > m} {η}_{0 m} {η}_{0 n} cos [ ( {β}_{0 m} - {β}_{0 n} ) L ]\end{matrix} \qquad ( 2 )$$

The second term on the right hand side of this equation represents interference between the modes of the fibre 10 which occurs when they are “recombined” at the output fibre 22. Since both the length L, and the propagation constants β₀ₘ depend upon environmental factors such as temperature and strain or bending, the output may be time-varying.

It is possible to think of this process as analogous to the speckle patterns commonly observed at the output of multi-mode fibres broadly illuminated by a visible source at the input face. The speckles are simply the result of a large number of modes, with different propagation constants, interfering spatially with each other. The bright spots are points of constructive interference, and the dark spots are points of destructive interference. If the fibre is disturbed, the speckle pattern shifts, as the phases of all the modes arriving at the output face of the fibre shift. In the case of the example outlined above, with reference to FIG. 2, the illuminating source is the guided mode of the input single-mode fibre 20, and one observes only the part of the output pattern that couples to the output single-mode fibre 22 (i.e. a circular area about 9 μm in diameter). One would not, however, expect to observe the same extremes of contrast between “bright” and “dark” periods as in the case of the speckle pattern. The single-mode input will predominantly excite the fundamental mode of the fibre 10. It will most likely significantly excite only a very small number of the other lower-order modes of the fibre 10, implying that there is only a very small number of interfering fields at the output end 26.

In the preferred embodiment, the fibre 10 supports a fundamental LP₀₁ mode that has an identical field profile to the fundamental mode of the single-mode fibres 20, 22. Ideally, then η₀₁=1, and η₀ₘ=0 (m≠1) and, according to Equation (2), Pₒᵤₜ/Pᵢₙ=1. In practice, it should be possible to ensure that η₀₁>>0, and η₀ₘ<<1 (m≠1).

In a second embodiment, the multi-mode core region 14 comprises a region of graded refractive index. Advantageously, this graded index profile is a parabolic index profile such that the transverse mode profiles of the optical fibre 10 closely match those of a typical graded-index multi-mode communications fibre. Accordingly more efficient coupling of power to and from graded-index multi-mode fibre may be achieved. Furthermore, a larger bandwidth-distance product may be obtained for multi-mode propagation in the optical fibre 10.

Presently, there are many single-mode fibre types in common use. These fibres all exhibit variations in fundamental mode profile, e.g. non-zero dispersion-shifted fibre (NZDSF) that is commonly used in modern WDM systems typically has a smaller effective area than standard single-mode fibre.

Accordingly, it made be desirable to provide a means to adapt the optical fibre 10 to a variety of single-mode fibre types that do not have well-matched transverse fundamental mode profiles.

A method to connect single-mode fibres of varying fundamental mode profiles to e.g. a network element which incorporates internal optical fibre connections embodying the present invention will now be described.

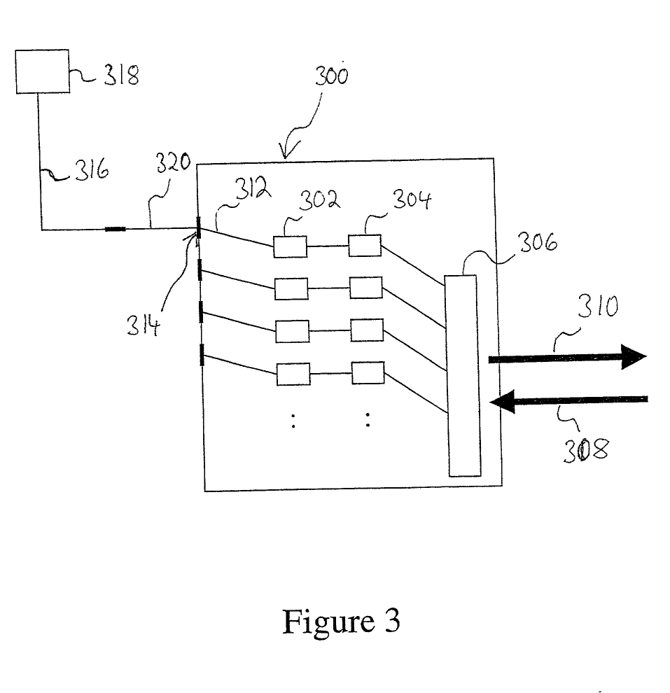

In FIG. 3, a network element 300 incorporates a plurality of line interface cards e.g. 302 and a plurality of trunk line interface cards e.g. 304 interfacing to channels of a WDM unit 306. The WDM unit 306 interfaces via its input and output streams 308, 310 to an optical network (not shown).

Internal fibre connections between the components incorporated in the network element 300 are formed from optical fibre e.g. 312 embodying the present invention. The scenario of connecting one of the subscriber line connections 314 to external single-mode fibre 316 of unspecified type for communication with the subscriber 318 will now be described.

As mentioned above, the optical fibre e.g. 312 most efficiently supports single-mode propagation of a particular mode that matches the fundamental mode of the optical fibre 312. Accordingly, to accommodate possible variations in the mode profiles exhibited by the external single-mode optical fibre 316, a length of perfectly matched single-mode fibre 320 is inserted between the line connection 314 and the external optical fibre 316. The optical connection between the external fibre 316 and the matched optical fibre 320 may be effected through single-mode connectors or through a splice.

The configuration shown in FIG. 3 will result in a larger average loss at the interface between the external optical fibre 316 and the matched optical fibre 320, with potentially some signal being coupled into cladding modes of the matched optical fibre 320. These modes can be stripped from the optical fibre 320 prior to the line connection 314. However, because the optical fibre 320 is one that is perfectly matched to the fundamental mode of the optical fibre connections e.g. 312 incorporated in the optical network 300, losses or interference effects within the network element 300 can ideally be avoided.

Accordingly, the configuration shown in FIG. 3 has the advantage that, when it is desired to upgrade a subscriber line from multi-mode fibre to single-mode fibre, only short lengths of perfectly matched single-mode optical fibre must be available at the network element side, to facilitate connection to potentially very long single-mode fibre subscriber lines which may exhibit variation in their mode profiles.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication the word “comprising” is used in the sense of “including”, i.e. the features specified may be associated with further features in various embodiments of the invention.

1. An optical fibre comprising at least one single core structure arranged in a manner such that, in use, it supports both single-mode and multi-mode propagation for data transfer.

2. An optical fibre as claimed in claim 1, wherein the fibre is arranged in a manner such that the fundamental mode of the single core structure is substantially matched to a transverse profile of a single-mode optical signal intended for propagation in the single core structure.

3. An optical fibre as claimed in claim 2, wherein the single core structure comprises an inner core region having a first diameter and a first refractive index, a second core region located concentrically around the first core region and having a second diameter and a second refractive index, and a cladding region having a third refractive index.

4. An optical fibre as claimed in claim 3, wherein the first refractive index is greater than the second refractive index which in turn is greater than the third refractive index.

5. An optical fibre as claimed in claims 3 or 4, wherein the first diameter is about 9 μm, and the second diameter is about 50 μm.

6. An optical fibre as claimed in any one of claims 3 to 5 wherein the second core region has a graded index profile along its diameter.

7. An optical fibre as claimed in claim 6, wherein the graded index profile comprises a parabolic refractive index profile.

8. An optical fibre as claimed in any one of the preceding claims, wherein the optical fibre is glass-based or polymer-based.

9. A method of connecting an optical fibre as claimed in any one of claims 1 to 8 to an external single-mode fibre having a mode-profile that is not substantially identical to a fundamental mode of the optical fibre, the method comprising the step of inter-connecting a length of matched single-mode optical fibre between the external single-mode fibre and the optical fibre, wherein the transverse single-mode profile of the matched single-mode fibre is substantially identical to the fundamental mode of the optical fibre.

10. An optical interconnecting device comprising an optical fibre as claimed in any one of claims 1 to 8.

11. An optical network element incorporating an optical interconnecting device as claimed in claim 10.
